(19) United States
(12) Patent Application Publication
(10) Pub. No.: US 2019/0381877 A1
(43) Pub. Date: Dec. 19, 2019

(54) COVER CLOTHS FOR VEHICLES

(71) Applicant: CONFEZIONI ANDREA ITALIA S.r.l., Varese (IT)

(72) Inventor: Redouane OTKY, Varese (IT)

(21) Appl. No.: 16/010,746

(22) Filed: Jun. 18, 2018

(51) Int. Cl. B60J 11/04

(52) U.S. Cl. CPC B60J 11/04

(57) ABSTRACT

A cover cloth for a vehicle, the cover cloth configured to be removably anchored to the vehicle so as to cover a body of the vehicle, the cover cloth may include: a cover portion for at least partially covering a windshield of the vehicle; and/or a zipper provided with an opening/closing slider positioned and/or configured so that when the cover cloth is constrained to the vehicle and the zipper is open, the cover portion for at least partially covering the windshield is partially uncoupled from a rest of the cover cloth and is partially removable so as to leave the windshield at least partially uncovered. The cover cloth may further include a flexible and manually graspable maneuvering element for maneuvering the opening/closing slider, the maneuvering element having a first end constrained to the cover cloth and a second end constrained to the opening/closing slider.

The present invention relates to a cover cloth for vehicles such as, for example, motor vehicles, vans, lorries and so on.

Currently car manufacturers, distributors and dealers of spare parts have available various types of cover cloths for vehicles, adapted to be used for the purpose of protection against atmospheric events, vandalism and accidental impact; such accessories protect the outer finish and body of the parked car.

Such cover cloths are normally also used to preserve the cars during their movements, which must necessarily be performed to transport them from one place to another, e.g. for taking them from the production factory where they were manufactured to the final dealer. These movements typically take place by loading the cars onto articulated lorries, ferries and other means of transport and may take a long time before final delivery, depending on the distance between the manufacturing area and the place of delivery to the customer.

For such movements, cover cloths are commonly used that can substantially cover all the body of the vehicle with the exclusion of the wheels; these cover cloths may be made so as also to cover the windshield of the vehicle. It is possible that during the journey, the need arises to move the vehicle, e.g. from one trailer to another; in these cases, it is necessary to remove the cover cloth from the vehicle to allow access thereto and guarantee visibility through the windshield.

To avoid removing the entire cloth, cover cloths are known wherein the portion of cloth intended to cover the driver side door and the one intended to cover the windshield can be reversibly uncoupled from the rest of the related cloth.

With particular reference to the cover portion of the windshield, it is known to arrange a zipper there which, when open, allows the lifting of such portion and the consequent exposure of the windshield.

However, this solution suffers from the drawback that in order to open or close the zipper it is necessary to operate on the slider first on one side of the windshield and then on the other. This is very inconvenient and difficult for the operator, especially when we consider the case in which the vehicle is positioned on a loading plane of a transporter where it is not always possible to pass from one side to the other side of the vehicle considering the small walking space that may remain between the vehicle and the borders of the loading plane. In these cases, therefore, the operator is obliged to perform a first opening or closing step of the zipper bringing the slider up to the maximum point that can be reached by his arms, descend from the loading plane and then go back up on the opposite side to complete the opening or closing operation.

The object of the present invention is that of overcoming the above-mentioned drawbacks and in particular that of designing a cover cloth for vehicles provided with a cover portion for covering the windshield that can be coupled or partially uncoupled simply and easily.

This and other objects according to the present invention are obtained by making a cover cloth for vehicles as outlined in claim 1.

Further features of the cover cloth for vehicles are the subject matter of the dependent claims.

The features and advantages of a cover cloth for vehicles according to the present invention will be more apparent from the following description, which is to be understood as exemplifying and not limiting, with reference to the schematic attached drawings, wherein:

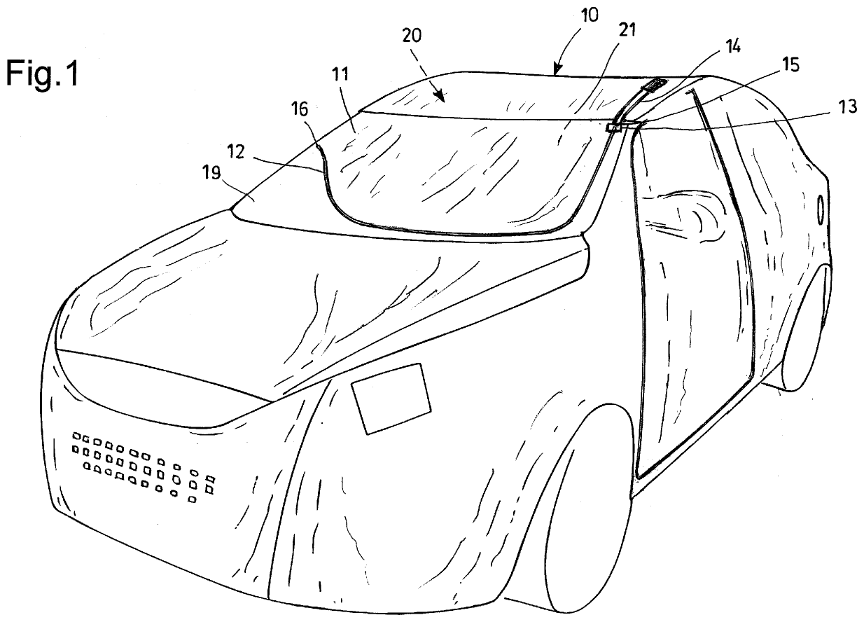

FIG. 1 is a perspective schematic view of a cover cloth for vehicles according to the present invention applied on a motor vehicle with a zipper in the closed position;

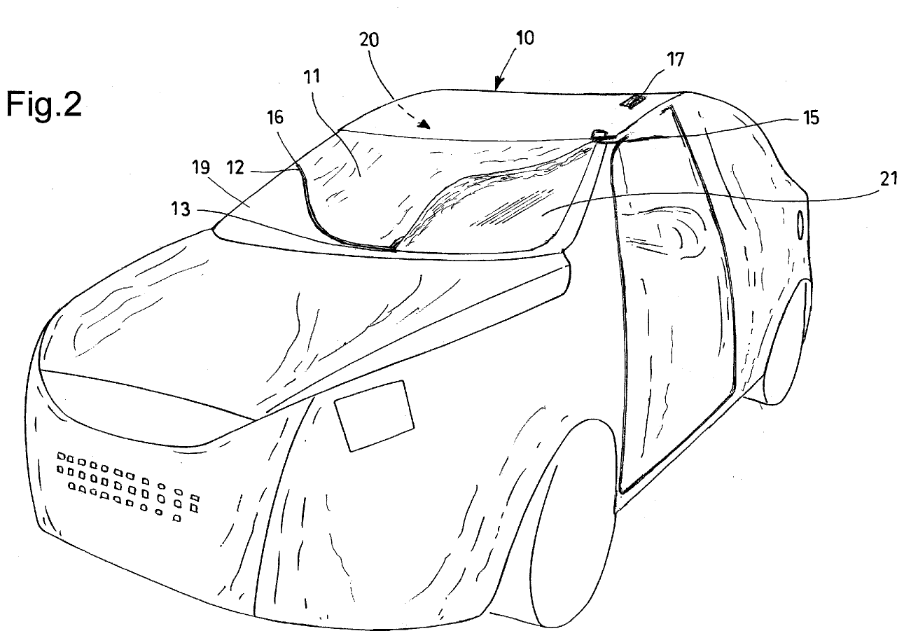

FIG. 2 is a perspective schematic view of the cover cloth of FIG. 1 with the zipper in the partially open position;

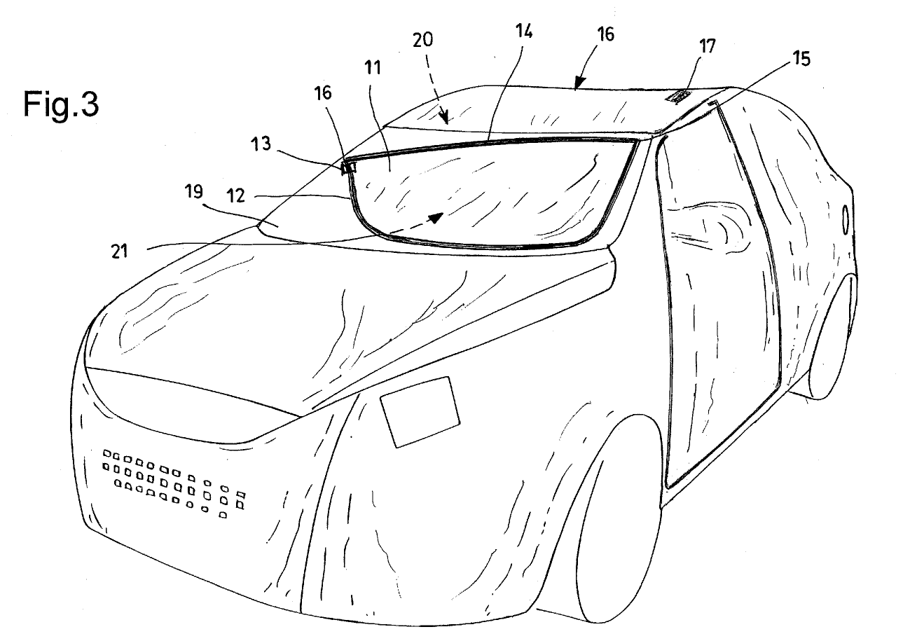

FIG. 3 is a perspective schematic view of the cover cloth of FIG. 1 with the zipper in the open position and the cover portion for covering the windshield resting on the windshield;

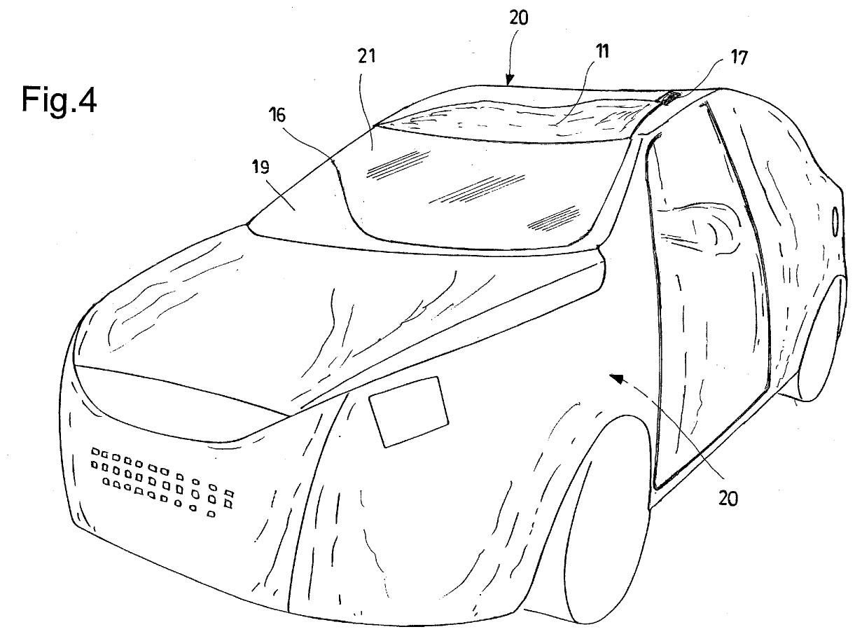

FIG. 4 is a perspective schematic view of the cover cloth of FIG. 1 with the zipper in the open position and the cover portion for covering the windshield raised so as to uncover the windshield;

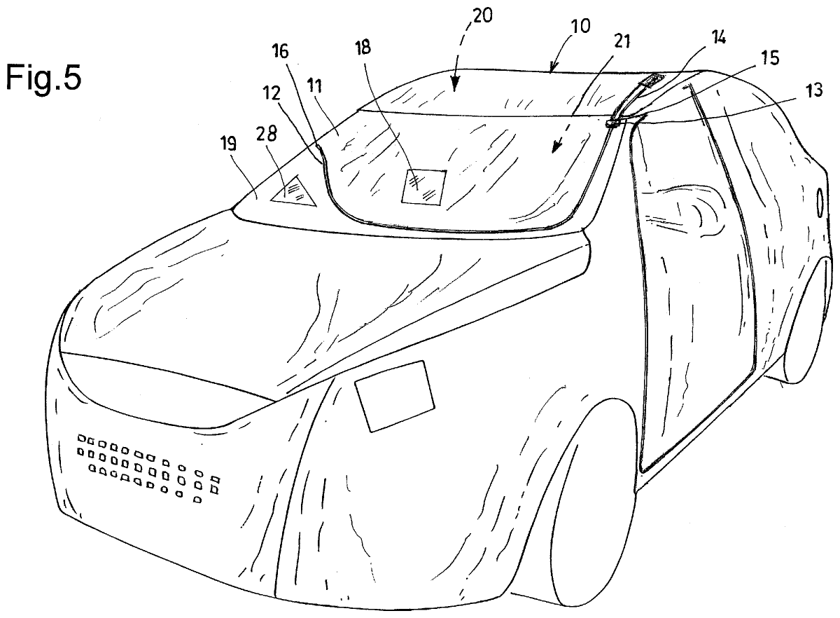

FIG. 5 is a perspective schematic view of a second embodiment of the cover cloth for vehicles according to the present invention applied on a motor vehicle with a zipper in the closed position.

With reference to the figures, a cover cloth for vehicles is shown, indicated overall with number 10. Such cover cloth 10 is arranged to be anchored to a vehicle 20 so as to cover its body; in particular, the cover cloth 10 is provided with hooking elements (not shown) adapted to be engaged with relative hooking portions of the body. For example, the hooking elements may be plaques or elastic straps and so on.

The cover cloth 10 is, in particular, shaped to substantially completely cover the vehicle, only excluding the wheels.

The cover cloth 10 comprises a cover portion 11 for at least partially covering a windshield 21 of the vehicle 20 and a zipper 12 provided with an opening/closing slider 13 positioned and configured so that, when the cover cloth 10 is constrained to the vehicle 20 and the zipper 12 is open, the cover portion 11 for covering the windshield 21 is partially uncoupled from the rest of the cover cloth 10 and is partially removable so as to leave the windshield 21 at least partially uncovered.

In practice, when the zipper 12 is open, it allows the cover portion 11 for covering the windshield to be grasped in order to define a window in the cover cloth 10 at the windshield in order to ensure visibility through it.

The cover portion 11 for covering the windshield may be entirely or partially made of opaque or transparent material; as illustrated in FIG. 5, the cover portion 11 is partially made of opaque material and has an area of transparent material 18.

According to an alternative, the cover portion 11 for covering the windshield may be entirely made of transparent material.

In the particular embodiments illustrated, the cover cloth 10 comprises an auxiliary cover portion 19 adapted to be connected to the cover portion 11 by means of the zipper 12 so as to substantially completely cover the windshield.

The auxiliary cover portion 19 may be entirely or partially made of opaque or transparent material; as illustrated in FIG. 5, the auxiliary cover portion 19 is partially made of opaque material and has an area of transparent material 28.

Alternatively, the auxiliary cover portion 19 for covering the windshield may be entirely made of transparent material.

According to the present invention, the cover cloth 10 comprises a flexible and manually graspable maneuvering element 14 for maneuvering the opening/closing slider 13, having a first end constrained to the cover cloth 10 and a second end constrained to the opening/closing slider 13.

The first end is, preferably, proximal with respect to the closing end stroke 15 of the opening/closing slider 13 and distal with respect to the opening end stroke 16 of the opening/closing slider 13.

The closing end stroke 15 corresponds to the end of the zipper 12 where the opening/closing slider 13 is positioned when the zipper 12 is completely closed.

Otherwise, the closing end stroke 16 corresponds to the end of the zipper 12 where the opening/closing slider 13 is positioned when the zipper 12 is completely open. Therefore, the first end of the maneuvering element 14 can be fixed to the cover cloth 10 so as to be closer to the closing end stroke 15 than to the opening end stroke 16.

In the embodiment illustrated in the figures, the first end of the maneuvering element 14 is constrained to the cover cloth 10 at the closing end stroke 15 of the opening/closing slider 13.

Preferably, the closing end stroke 15 of the opening/closing slider 13 is positioned at the driver side of the vehicle but it may also be positioned at the passenger side.

Preferably, the zipper 12 has no safety catch. This allows the zipper 12 to be opened by maneuvering the opening/closing slider 13 for a short stretch obtaining two opposite flaps of cloth uncoupled from each other and then subsequently manually widening these two flaps of cloth causing the translation of the opening/closing slider up to the respective opening end stroke 16.

Preferably, the maneuvering element 14 has an elongated shape. In that case, the maneuvering element 14 is, preferably, tape-shaped.

Alternatively, the maneuvering element 14 may be rope-shaped. The maneuvering element 14 may be elastic.

Preferably, the cover cloth 10 and the maneuvering element are provided with reciprocal anchoring elements 17 arranged to directly or indirectly anchor the maneuvering element 14 to the cover cloth 10.

In particular, such anchoring elements may comprise a Velcro® closing system.

In the embodiment illustrated, when the zipper 12 is closed, the tape-shaped maneuvering element 14 is refolded and anchored indirectly to the cover cloth 10 at the roof of the motor vehicle through a strap associated with the maneuvering element 14 which is coupled with a Velcro® band 17. Alternatively, if the maneuvering element is made with a material that can be coupled to the Velcro® band 17, it is possible to anchor the maneuvering element 14 directly to such Velcro® band 17.

According to a further alternative, the cover cloth 10 may be provided with a buttonhole to which it is possible to fix the strap of the maneuvering element 14. In any case, different possible reciprocal anchoring elements can be provided, for example also those based on adhesive bands.

The cover cloth 10, according to the present invention, is used in the following way.

Let us consider the cover cloth 10 as being applied to a motor vehicle 20 with the zipper 12 closed and the maneuvering element 14 anchored to the cloth itself as shown in FIG. 1. The embodiment is considered in which the closing end stroke 15 is positioned at the driver side of the vehicle and in which the zipper 12 has no safety catch.

When the operator needs to move the motor vehicle 20 without removing the cover cloth 10 he must necessarily open the cloth itself at the windshield 21.

At this point, the operator releases the maneuvering element 14 and makes the opening/closing slider 13 slide along a stretch of zipper. Then he grasps the two free flaps obtained and widens them by making the opening/closing slider 13 slide up to the opening end stroke 16. At this point, the operator can lift the cover portion 11 for covering the windshield 21 and anchor it to the cover cloth 10 for example using the same Velcro® band 17.

After moving the vehicle into the desired position, the operator can, through the maneuvering element 14, easily close the zipper 12 in the same position from which he previously opened it. In fact, the operator grasps the maneuvering element 14 and pulls it making the opening/closing slider 13 slide towards the closing end stroke 15.

This is very advantageous when the vehicle is positioned in areas where it is not possible to transit easily from one side to the other of the vehicle, e.g. on the loading planes of trailers of trucks.

From the above description the features of the cover cloth object of the present invention, as well as the advantages thereof, are evident.

Finally, it is clear that the cover cloth as conceived herein is susceptible to many modifications and variations, all falling within the invention; furthermore, all the details are replaceable by technically equivalent elements. In practice, the materials used, as well as their dimensions, can be of any type according to the technical requirements.

1. A cover cloth for a vehicle, the cover cloth configured to be anchored to the vehicle so as to cover a body of the vehicle, the cover cloth comprising:
a cover portion for at least partially covering a windshield of the vehicle; and
a zipper provided with an opening/closing slider positioned and configured so that when the cover cloth is constrained to the vehicle and the zipper is open, the cover portion for at least partially covering the windshield is partially uncoupled from a rest of the cover cloth and is partially removable so as to leave the windshield at least partially uncovered;
wherein the cover cloth further comprises a flexible and manually graspable maneuvering element for maneuvering the opening/closing slider, the maneuvering element having a first end constrained to the cover cloth and a second end constrained to the opening/closing slider.

2. The cover cloth of claim 1, wherein the first end is proximal with respect to a closing end stroke of the opening/closing slider, and
wherein the first end is distal with respect to an opening end stroke of the opening/closing slider.

3. The cover cloth of claim 1, wherein the zipper has no safety catch.

4. The cover cloth of claim 1, wherein the maneuvering element has an elongated shape.

5. The cover cloth of claim 4, wherein the maneuvering element is tape-shaped.

6. The cover cloth of claim 1, wherein the first end of the maneuvering element is constrained to the cover cloth at a closing end stroke of the opening/closing slider.

7. The cover cloth of claim 6, wherein the closing end stroke of the opening/closing slider is positioned at a driver side of the vehicle.

8. The cover cloth of claim 1, wherein the cover cloth and the maneuvering element are provided with mutual anchoring elements configured to directly or indirectly anchor the maneuvering element to the cover cloth.

9. The cover cloth of claim 1, wherein the cover portion is entirely or partially made of opaque or transparent material.

10. The cover cloth of claim 1, comprising an auxiliary cover portion configured to be connected to the cover portion using the zipper, and
wherein the auxiliary cover portion is entirely or partially made of opaque or transparent material.

11. The cover cloth of claim 1, wherein the maneuvering element is tape-shaped.

12. The cover cloth of claim 1, wherein the maneuvering element is rope-shaped.

13. The cover cloth of claim 1, wherein the maneuvering element comprises elastic material.

14. The cover cloth of claim 1, wherein the maneuvering element is elastic.

15. The cover cloth of claim 1, wherein a closing end stroke of the opening/closing slider is positioned at a driver side of the vehicle.

16. The cover cloth of claim 1, wherein a closing end stroke of the opening/closing slider is positioned at a passenger side of the vehicle.

17. The cover cloth of claim 1, wherein the cover portion partially comprises transparent material.

18. The cover cloth of claim 1, comprising an auxiliary cover portion configured to be connected to the cover portion using the zipper, and
wherein the auxiliary cover portion partially comprises transparent material.

19. A cover cloth for a vehicle, the cover cloth configured to be removably anchored to the vehicle so as to cover a body of the vehicle, the cover cloth comprising:
a cover portion for at least partially covering a windshield of the vehicle;
a zipper provided with an opening/closing slider; and
a manually graspable maneuvering element configured to maneuver the opening/closing slider;
wherein the zipper is positioned so that when the cover cloth is constrained to the vehicle and the zipper is open, the cover portion for at least partially covering the windshield is partially uncoupled from a remainder of the cover cloth and is partially removable so as to leave the windshield at least partially uncovered, and
wherein the maneuvering element has a first end constrained to the cover cloth and a second end constrained to the opening/closing slider.

20. A cover cloth for a vehicle, the cover cloth configured to be removably anchored to the vehicle so as to cover a body of the vehicle, the cover cloth comprising:
a cover portion for at least partially covering a windshield of the vehicle;
a zipper provided with an opening/closing slider; and
a manually graspable maneuvering element configured to maneuver the opening/closing slider;
wherein the zipper is configured so that when the cover cloth is constrained to the vehicle and the zipper is open, the cover portion for at least partially covering the windshield is partially uncoupled from a remainder of the cover cloth and is partially removable so as to leave the windshield at least partially uncovered, and
wherein the maneuvering element has a first end constrained to the cover cloth and a second end constrained to the opening/closing slider.
